(19) United States
(12) Patent Application Publication
(10) Pub. No.: US 2009/0075073 A1
(43) Pub. Date: Mar. 19, 2009

(54) Light weight concrete product containing synthetic fibers

(76) Inventors: Daniel T. Biddle, Grove City, PA (US); L. Keith Davis, Stephenville, TX (US); Jeffrey B. Lovett, Harrisville, PA (US); Charles D. Welker, Dallas, TX (US)

Correspondence Address: K&L GATES LLP, 535 SMITHFIELD STREET, PITTSBURGH, PA, 15222, US

(21) Appl. No.: 11/983,193

(22) Filed: Nov. 7, 2007

Related U.S. Application Data
(60) Provisional application No. 60/858,569, filed on Nov. 13, 2006.
(60) Provisional application No. 60/904,633, filed on Mar. 2, 2007.

(51) Int. Cl. B32B 5/16; C04B 24/26; C04B 24/28

(52) U.S. Cl. 428/339; 524/8; 524/2

(57) ABSTRACT

A method is provided for producing a light weight, low to medium density product from gasified or aerated liquids and gels, such as air-entrained concrete. The method includes mixing cement, aggregate, water, air bubbles, a foam stabilizing agent and a plurality of suspension elements together to form a concrete mixture, pouring the mixture into a form and allowing the mixture to harden in the form. The suspension elements include synthetic fibers, such as polyolefin, nylon or polyester monofilaments, wherein each monofilament has a denier of less than 15 and a length of greater than 0.635 cm to 1.905 cm (¼ inch to ¾ inch).

### CROSS REFERENCE TO RELATED APPLICATIONS

The present application claims priority under 35 U.S.C. § 119(e) from co-pending U.S. Patent Application Ser. Nos. 60/858,569 filed Nov. 13, 2006 and 60/904,633 filed Mar. 2, 2007 the entire disclosures of which are hereby incorporated by reference herein.

### BACKGROUND OF THE INVENTION

1. Field of the Invention

The invention relates to the use of synthetic fibers as suspension elements in gasified or aerated liquids and gels, and more particularly to light weight products, such as air-entrained concrete products containing fibrous suspension elements.

2. Invention Background

There have been ongoing efforts for several decades to produce strong, durable concrete with improved properties. Concrete, as used for structural as well as non structural purposes, is a composite material that is often composed of water, cementitious materials (such as cement, fly ash, slag and/or pozzolanic material), and aggregate. Common aggregates include sand, gravel, or crushed stone. Aggregates used in concrete mixes generally consist of some larger or coarse rock particles, smaller aggregate, such as pea gravel, and finer sand particles of various sizes. Concrete is a well-known structural component with typical compressive structural strengths of at least 17,236.9 KPa (2500 psi). Non structural applications cover a very wide spectrum of products and uses, which could have compressive strength performance as low as 241.3 KPa (35 psi). One example of a non structural use of concrete is in soil stabilization where the compressive strength requirement, in many cases, should not exceed 1723.7 KPa (250 psi). More detailed discussions regarding concrete and its properties can be found in Concrete, by S. Mindess and J. F. Young (Prentice Hall, Inc, Englewood Cliffs, N.J. 1981), in Design and Control of Concrete Mixtures, 13.sup.th Ed., by H. Kosmatka and W. C. Panarese (Portland Cement Association, Skokie, Ill., 1988), and in the ACI Manual of Concrete Practice (American Concrete Institute, 1987).

Concrete is often made by mixing water with dry cement and aggregate to produce a flowable concrete mixture which is poured in place at a construction site and/or poured into forms or molds of a desired shape. Dry cement typically consists of very fine particles of a cement material such as Portland cement or the like. The particles may be in the form of relatively flat flakes and have a size of the order of 0.00254 cm (0.001″). When mixed with water, the cement forms a paste and will act as a glue between the larger sand and rock particles. The water to cement ratio is often critical in determining the strength of the hardened concrete, with a lower water content producing stronger concrete. There must be sufficient water, however, to adequately hydrate the components of the mixture and to allow the mixture to flow. Thus, simply reducing the water content is not possible, since the concrete mixture will no longer be readily workable.

Air entrained concrete has been advanced for providing a lighter weight concrete for certain applications and for reducing the water content in cement mixes, but not without problems. Air bubbles introduced into a cement mix form small air cells in the concrete. Historically, air voids in concrete are unstable because the air dissipates during the mixing process or during travel. Air voids in concrete can also be chemically unstable. As more air is mixed into concrete, the concrete becomes more liquid and the solids have a tendency to settle out of the mix. Because of the fragile nature of the air or bubbles it is sometimes necessary to adjust the air content or possibly introduce the air or bubbles at the job site, a practice which results in limiting the volume of concrete that can be effectively or predictably replaced by air cells. Viscosity modifying agents (VMAs) are often added to thicken a concrete mixture, changing it from a watery mix, which is not uniform or cohesive, to a higher viscosity, gel-like mixture in an effort to keep the air and aggregate in suspension and the overall mix cohesive while the concrete mixture hardens.

Because of the inherently low density of gases and their relative abundance or ease of generation, their incorporation can have significant advantages for lowering the density of concrete. There are two fundamentally different approaches to incorporating air or other low density gases. One approach generates gas in situ by chemical reaction and the other approach generates small pockets of air or gas either by whipping the concrete or by including preformed bubbles or foam into the wet mix before curing. The in situ generation of gas typically involves the production of hydrogen gas from the base catalyzed reaction of a finely divided reactive metal species such as aluminum.

Foams are often generated separately using surfactants and other foaming agents in combination with water and air before being introduced to a premixed paste of cement, water, and aggregate. Cellulose based foaming agents are described by Kuramoto et al. in U.S. Pat. No. 3,963,507. Bouchard et al. in U.S. Pat. No. 4,373,955 described a hydrolyzed protein based foaming agent and a hydrolyzed protein based foaming concentrate.

One method has been disclosed wherein liquid concrete (cement, water and aggregate) is mixed with a foaming agent to produce a foamed concrete material which can be pre-cast in a mold or cast on site, to produce air-entrained, lightweight concrete on drying. The use of such foaming agents can produce a thick, creamy foam of fine bubbles which are resistant to collapse during mixing with concrete. Because the bubbles are retained within the concrete material for longer periods of time without collapsing, they remain in the concrete when it is cast or placed in a form. As the concrete hardens, the bubbles disintegrate and release water, which is absorbed into the cement, thereby hydrating the cement mixture and leaving air voids of similar sizes. Foaming agents, expansion materials and surfactants for mixing with water are commercially available. The foaming agents have not, however, been successful in suspending course aggregate.

The actual mixing sequence of the foam, cement, water, coarse aggregate (rock), medium aggregate (gravel) and sand may be varied. A typical sequence would involve adding coarse and medium aggregate, cement, foam and water to the mixer, then adding sand and mixing for a short time interval before adding a second quantity of foam and mixing again. The foam acts as a plasticizer to disperse the cement paste throughout the mix. When mixed with water, a paste of wetted cement particles, the smallest size bubbles, and the smallest size sands will be produced. This paste forms a coating around the larger sized aggregates and sands, and also forms areas of solid paste in any remaining gaps in the concrete matrix. The mixture of bubbles in the paste has a ball bearing effect, increasing flowability of the paste and allowing it to fill up any remaining gaps in the mixture more easily.

In prior art concrete mixtures, it was considered essential to have about 60 to 70% of rock or coarse aggregate particles and about 30% to 40% sand particles in an aggregate mixture to produce high quality concrete. This is because the strength of the resultant concrete is largely dependent on good cement paste coverage of the surface area of all aggregates at a low water to cement ratio with good flowability throughout the concrete mass. However, by mixing the foam of stable, small size bubbles into a concrete mix of cement and aggregate, the percentage of sand used in the aggregate is generally increased to 40 to 50%. The amount of sand is increased in these concrete mixes because the sand prevents the air and water from migrating to the top of the mix. Sand supports the air and water but weighs more than coarse and medium aggregate. Sand has a high surface area relative to larger aggregate, therefore requires more cement paste to coat the sand particles so that less cement paste is available for strengthening the concrete.

Normal dense weight air-entrained concrete has a weight reduction of no more than 8.5% due to air content, and typically, about 6%. Attempts at weight reduction above 8.5% with conventional structural solids, reduce the suspension capacity of the solids in the concrete to the point of not being usable.

### SUMMARY OF THE INVENTION

A method is provided for producing a light weight, low to medium density product comprised of gasified or aerated liquids and gels and a plurality of suspension elements to suspend the air and aggregate in the liquid or gel. The method permits production of a product that is lighter in weight and lower in density than conventional light weight concrete products. In one embodiment, the light weight product may be formed from an air-entrained concrete mix, typically comprising cement, aggregate, water, air bubbles in the form of foam or made with a stabilizing agent, and suspension elements in the form of synthetic fibers. The precise concrete mix will depend on the desired end product, but, unlike prior art air-entrained concrete mixes, the method of the present invention allows more freedom in modifying the mix design. By using the suspension elements of the invention, the aggregate may comprise less sand to suspend air and coarse aggregate and to prevent the escape of water.

In one embodiment, the method for producing a light weight, low to medium density product comprises mixing together (i) cementitious components comprising cement and water, and aggregate, (ii) a plurality of suspension elements comprising synthetic fibers and (iii) an agent for lowering the unit weight of the product, to form a concrete mixture. The method further comprises the steps of pouring the concrete mixture into a form and allowing the mixture to harden. Each of the synthetic fibers of the suspension elements have a denier of less than 15, a length greater than 0.635 cm (¼ inch) and less than 1.905 cm (¾ inch) and are made of a material selected from the group consisting of polyolefin, nylon and polyester. The aggregate may comprise at least one of sand, fine aggregate and coarse aggregate.

The method may comprise distributing the suspension elements throughout a slurry of the cementitious components after the cementitious components are mixed, and adding thereto the unit weight lowering agent. Alternatively, the method may comprise adding the suspension elements to the cementitious components, mixing the suspension elements and the cementitious components together, adding the unit weight lowering agent, and mixing the unit weight lowering agent with the suspension elements and the cementitious components for a period of time sufficient to disperse the unit weight lowering agent throughout the concrete mixture.

The concrete mix may therefore include, in addition to cement, air bubbles, a foam stabilizing agent and a plurality of suspension elements, greater percentages of medium and large sized aggregate than heretofore possible for stable, air-entrained concrete products. Any suitable foam stabilizing agent may be used, such as the foam stabilizing surfactant sold under the mark, MIRACON® by Miracon Technologies, Inc. and described in U.S. Pat. No. 6,153,005, which is incorporated herein by reference.

The synthetic fiber suspension elements are preferably in the form of monofilaments, wherein each monofilament has a denier of less than 15 and a length of about 0.635 cm to 1.905 cm (½ to ¾ inch). In one embodiment, the suspension elements may be polyolefin monofilaments having a denier between 2 and 7 and a length of about 0.635 cm to 1.905 cm (½ inch to ¾ inch), and most preferably a polypropylene monofilament having a denier between 3 and 7 and a length of 0.635 cm (½ inch). Some deviation in the length may be tolerated.

A method is provided for producing the light weight, low to medium density product which includes mixing cement, sand, aggregate, water, air bubbles in the form of a foam or air made with a foam stabilizing agent and a plurality of the suspension elements together to form a concrete mixture, pouring the concrete mixture into a form and allowing the mixture to harden.

The method of the present invention relies on the improved suspension capacity of the plurality of synthetic fibers dispersed throughout the concrete mixture. The fibers disperse in the concrete mixture to create a homogenous matrix of suspended fibers for suspending air bubbles and aggregate.

As stated above, sand in a conventional air-entrained concrete mix supports the air and water but weighs more and has a high surface area relative to larger aggregate, therefore requiring more cement paste to be devoted to coating the sand particles. With the addition of the fine fibers, the sand may be replaced with larger aggregate, such as crushed rock and pea gravel. The concrete weight per unit area will be less and the surface area will be less, thereby requiring less cement paste devoted to coating particles and allowing more cement to strengthen the concrete mix.

### DETAILED DESCRIPTION

As used herein with reference to concrete, “light weight” means a typical weight reduction of 10% or more, and preferably about 15% or more, as compared to a standard amount of concrete of equal dimensions. Weight reductions in the range of about 20-30% are common for the light weight concrete of the present invention. Conventional normal-weight concrete compositions are typically in the range of 2082-2563 kg/m³ (130-160 lb/ft.³). Conventional lightweight structural and non structural concrete compositions are typically found to be in the range of 240-2082 kg/m³ (15-130 lb/ft.³).

As used herein, “fine fibers” means synthetic fibers having a denier of less than 15.

As used herein “form” in the context of the method for producing a light weight, low to medium density product means a natural or prepared structure into which the concrete mixture is poured to form at least a portion of the desired product.

Although the present invention will be described by reference to the method of forming air-entrained concrete described in U.S. Pat. No. 6,153,005, those skilled in the art will recognize that there are numerous alternative methods of producing air bubbles in concrete and that the fibers described herein may also be used with air-entrained concrete or foamed concrete obtained by such other means.

The concrete mix of the present invention may comprise from about 1 to about 50 percent by volume of cement, from about 0 to about 75 percent by volume of washed sand, from about 0 to about 60 percent by volume of coarse aggregate, from about 4 to about 50 percent by volume water, from about 0 to about 50 percent by volume of a member selected from the group consisting of cementitious and pozzolanic materials, from about 0 to about 0.6 kg (20 oz) of water reducer per 45 kg (100 pounds) of cementitious and pozzolanic material, from about 0 to about 0.6 kg (20 oz) of accelerator per 45 kg (100 pounds) of cementitious and pozzolanic material, from about 1 to about 90 percent by volume of air as bubbles, comprising from about 0.01 to about 20.0 percent by weight of a fluorochemical foam stabilizer, and from about 0.59 to about 11.87 kg (1 to about 20 lbs) of fiber suspension elements per cubic yard of concrete.

In the method described in U.S. Pat. No. 6,153,005, a fluorochemical foam stabilizer, which may be characterized as a fluorinated surfactant, is added to the concrete mix. According to that method, the fluorochemical foam stabilizers improve the stability and resilience of foams when in contact with cementitious compositions. The bubbles of these derived foam aggregates retain their discreet structures throughout various processing steps such as transportation, pumping, molding, and curing. The high stability and resilience of the resultant foams enable their use as novel stable ultra-lightweight aggregates in combinations with other concrete components including but not limited to water, cement, hydraulic hydrated lime, ground granulated iron blast furnace slags, sand, silica, stone, other, natural and byproduct pozzolanic materials, as well as chemical admixtures such as water-reducers and super plasticizers. The fluorochemical foam stabilizers enable exceptionally stable foam or air in concrete mixes which are economical in lightweight to near normal-weight, high performance concrete compositions.

While the stabilized foams are useful in producing concrete compositions that also contain common aggregates such as sand, gravel, or crushed stone, they also have utility in their own right as “foam aggregates” to provide unique ultra-lightweight aggregate when no sand or other common aggregate is used. The stabilized foam can be the only aggregate for very low density concrete for use, for example as insulation.

The preferred foaming concentrates are comprised of aqueous solutions of fatty alcohols preferably selected from the group consisting of straight and branched chain fatty alcohols of 8 to 16 carbon atoms and mixtures thereof, a polysaccharide gum preferably selected from the group consisting of Rhamsan gums, Xanthan gums, Guar gums and Locust Bean gums, and a non-fluorinated anionic surfactant preferably selected from the group consisting of C-8 to C-18 anionic surfactants and most preferably, C-10 to C-18 alpha olefin sulfonates, as well as mixtures of such surfactants. The concentrate may also contain a solvent, preferably selected from the group consisting of glycol ethers and C-2 to C-8 aliphatic diols.

The cementitious and pozzolanic materials of this composition are those well known in the concrete art, namely, such materials as fly ash (both types C and F), ground blast furnace slag, diatomaceous earth, hydrated lime, natural cement, etc. Water reducing chemicals are also well known in the art. Non-limiting examples of such materials are lignosulfonates, sulfonated melamine formaldehyde and naphthalene formaldehyde condensates, hydroxylated carboxylic acids, and carbohydrates. Set accelerating mixtures include such materials as calcium chloride, triethanol amine, sodium thiocyanate, calcium formate, calcium nitrate, and calcium nitrite.

Foam production can be performed by drawing water and concentrate from separate sources, in the ratios described above, and injecting them using high pressure air or other suitable gas, preferably at about 861.8 KPa (125 psi), into a chamber where the mixture is subjected to shearing forces and thereby producing stabilized bubbles or foam. Any number of foam production devices may be used for producing the stabilized foam of the present invention, and the invention is not limited to any specific such device. Such devices are well known in the art and familiar to the skilled artisan. Whatever mechanism used, it must be adequate to produce a stream of bubbles suitable for introduction into an appropriate concrete mixture.

An example of the preparation of a cellular concrete material follows:

### EXAMPLE 1

A 0.198 m³ (7.0 ft.³) paddle-type mortar mixer is charged with 15.9 kg (35.0 lb) of water, 103.2 kg (227.5 lb) of washed sand, 490.9 kg (110 lb) of Type I/II Portland cement (Texas Industries, Inc.), and 71 grams (2.5 oz) of Daracem™ ML 330 (a water reducer-super plasticizer available from W. R. Grace). Subsequent mixing at 32 r.p.m. for 5-10 minutes produces a uniform cementitious slurry.

A stable and resilient aqueous foam aggregate was produced separately by diluting an aqueous concentrate comprised of sodium alkenyl sulfonates (7.0 w/w %), 1-t-Butoxy-2-propanol (5.0 w/w %), Rhamsan gum (2.0 w/w %), Perfluorioethylthia acrylic telomer (1.4 w/w %), n-Alkanois (1.0 w/w %), 2-Methyl-2-propanol (0.2 w/w %) to 2.5 w/w % water (39 parts water to one part of the concentrate, respectively) and then aerating it through a foam generating chamber where the mixture is subjected to shearing forces to produce the stabilized foam aggregate. While continuing to mix the cementitious slurry, 0.028 m³ (1.0 ft.³) of the foam aggregate is added to the slurry over approximately one minute. The resultant cellular concrete slurry should be mixed for about 5 minutes to uniformly disperse the foam aggregate, but can be mixed in excess of 90 minutes without any loss of foam aggregate volume. The cellular concrete slurry is very flowable and readily pours into a desired form or mold. The compressive strengths of the foregoing mix were determined to be 14,479-15,237 KPa (2100-2210 psi) after 7 days and 2840-3080 psi after 28 days. All of the samples had a density of 1713.9 Kg/m³ (107 lb/ft.³).

In the method of the present invention, suspension elements comprised of synthetic fibers are added to the concrete slurry before, during or after mixing and prior to the addition of the foam aggregate.

Small air voids, referred to also as air bubbles, are more desirable for higher strength than a larger air voids of the same total volume. By suspending and dispersing the numerous small air voids throughout the concrete, the resulting product achieves the desired weight reduction and design strength. The problem heretofore experienced with other foamed concrete products due to the difficulty in easily and uniformly suspending different sized aggregates is overcome by the addition of the suspension fibers described herein. In the product of the present invention, the aggregate suspends uniformly throughout the concrete matrix. As the tests described herein demonstrate, not all fibers work. It was surprisingly found that the properties unique to fine fibers come into play. Larger fibers failed to suspend the air and aggregate as desired. Larger fibers do not provide thixotropic properties.

Using air in concrete reduces the weight of the concrete. The more air that can be introduced, the greater the weight reduction can be achieved. The fibers allow the aggregate to uniformly suspend throughout the mix, which in turn, insures an optimal concrete matrix. There is a synergy between the two. The concrete matrix is defined by the aggregate. When everything is fairly uniform throughout the mix the performance requirements, especially strength, of the product is more effective and it is more cost effective to make.

Unlike prior air-entrained light weight concrete products, light weight concrete products of the invention are very stable because of the high strength properties achieved by the reduction of sand and the increased levels of larger aggregate, which is believed to allow more of the cement paste to contribute to overall strength, all made possible by the addition of fine fibers.

The range of materials that can be used in an air-entrained, fiber suspended concrete mix follows:

Volume/Weights of materials per cubic yard of concrete
1. Cementitious Materials—0 to 544 kg (1200 lbs)
2. Aggregate (sand and rock)—0 to 1587.6 kg (3,500 lbs)
3. water—20% to 300% by weight of the cement
4. air—1% to 95% by volume of the total concrete mix
5. fiber—0.45 kg to 9.07 kg (1 lbs to 20 lbs)
6. admixtures—0 L per 50.8 kg (0 oz. per cwt.) to 13.2 L (3 gallons) per cwt of the cementitious material. Admixtures include, but are not limited to, water reducers, retarders, accelerators, hydration stabilizers, and other concrete additives known in the industry.

The properties of the fibers found to be effective for increasing strength and stability, maintaining the sieve size and reducing cost of the concrete product are its length, denier, shape and chemistry. With respect to chemistry, the fibers may be nylon, polyester or a polyolefin, such as polypropylene and polyethylene. The shape of the fibers is preferably a monofilament which may be in generally flat strips or, on average, in a cylindrical shape. The fiber length found to be effective is about 1.27 cm (½ inch), but may range from greater than 0.635 cm (¼ inch) to less than 2.54 cm (one inch) and preferably from about 1.27 cm to 1.905 cm (½ to ¾ inch). The denier found to be effective is less than 15, but preferably in the range from 2 to 7, and more preferably from 3 to 7. The optimum denier and length may vary for different materials.

The fiber content is about 2.37-2.97 kg per cubic meter (4-5 lbs. per cubic yard) of concrete. Normal concrete is about 2076 to 2373 kg/cubic meter (3,500 to 4,000 lbs/cubic yard). Light weight concrete may be 10% and is typically 14-15% to about 25% less in weight, or about 1483-2017 kg per cubic meter (500-3,400 lbs. per cubic yard) of concrete. Variation in the concentration of fibers can be tolerated, as any effective amount of fiber may be used and depends on the desired end use of the concrete product and the mix design. Although a dosage of fiber above 2.37-2.97 kg per cubic meter (4-5 lbs per cubic yard) of concrete may be used, the carrying capacity of the fibers appears to level off so that dosages above 2.97 kg of fiber per cubic meter (5 lbs of fiber per cubic yard) are not believed to be cost effective for most uses when the fibers are used as suspension elements.

The fibers are most preferably comprised of a plurality of filaments processed in a tow form in bundles, strips or monofilaments of less than about 15 denier, and preferably from 2-7 denier per filament (dpf). The fibers may be naturally hydrophilic or hydrophobic, or may be coated with a hydrophilic or hydrophobic coating. In addition to external surface treatment, one skilled in the art would appreciate that it is also possible to create hydrophilic or hydrophobic properties by internal methods. This could be accomplished, for example, by way of chemical and polymer grafting. The attachment of graft coatings is accomplished by forming a covalent bond between the substrate and the monomers via the graft initiator. As a result, when compared to conventional coatings much thinner coatings can be obtained while providing good strength and adhesion properties of the material. The chemical reaction that takes place provides subsurface penetration and chemical bonding. Coating thickness can be adjusted according to specification. Other internal methods, such as, for example, co-polymer extrusion and the addition of additives during the extrusion process also may be employed to achieve desired hydrophilic properties. For example, a simple additive designed to create ultra-violet stability in a raw material may also cause the end result to be hydrophilic. Examples of suitable fibers include polypropylene, polyethylene, nylon and polyester. The most preferred fiber is a polypropylene.

In one embodiment, the concrete is premixed. Fibers cut into the desired lengths are added to the desired concrete mixture and mixed to evenly disperse the fibers throughout the mixture. Air bubbles are then added as described above.

Lightweight concrete mixes having very low to moderately high viscosities were tested with conventional VMAs, large denier fibers and fine denier fibers. Surprisingly, only the fine denier fibers worked to consistently and predictably suspend the aggregate.

A series of tests were conducted to determine the characteristics of the fibers best suited for use with the air-entrained concrete.

### EXAMPLE 2

A 0.1 cubic meters (3.5 cubic foot) concrete drum mixer is charged with 8.35 kg (18.4 lbs) of water, 29.76 kg (65.6 lbs) of concrete sand, 5.03 kg (11.1 lbs) of 0.95 cm (⅜″) rock, 30.8 kg (67.9 lbs) of #57 rock 2.54 cm (1″), 30 kg (66.1 lbs) of cement, 136.6 ml of Glenium 3030™ (a water reducer/plasticizer), 29.3 ml of Delvo™ (a hydration stabilizer), 133 grams (4.7 oz.) of fiber, and 6.6% cubic meter (feet) of an air entraining agent, such as the foam stabilizing fluorinated surfactant disclosed in U.S. Pat. No. 6,153,005, which is incorporated herein by reference in its entirety. The concrete mixer is turned on at a mixing speed which insures that all ingredients are mixed together in approximately 2 minutes. After initial mixing, the drum mixer continues to turn at a slow rate—approximately 3-4 rpm. Samples of the mix are taken at 10 minute intervals to determine if any weight change occurred, which would be indicative of air volume change. During the sample time, all weights recorded were within ±2% of the target 1842 kg pound unit weight per cubic meter (115 pound unit weight per cubic foot), which is a commercially acceptable tolerance. The consistency of unit weight measurement, as indicated by the sample weights taken, would indicate uniformity of air volume over time and that all materials were being uniformly suspended during the mix time.

The following tables provide the measurements taken for a series of tests performed according to the foregoing Example 2, with variations as noted in the Tables.

TABLE 1
Mix Design Using Light Weight Sand

| | | | | Cubic | | | |
|---|---|---|---|---|---|---|---|
| | | | Absolute | Yard | | | 3 ft³ |
| | | | Volume | Batch | | | Batch |
| | | | Cubic | Weight | Mix % | Mix % | Weight |
| | | Specific | meter | in kg | by | by | in kg |
| Materials | | Gravity | (cu.ft.) | (lb.) | Volume | Weight | (lb) |
| Cement (Gray- | Bags | 3.15 | 0.1 | 310.5 | 13.0% | 42.8% | 34.4385 |
| Type I/II) | 7.3 (94#) | | (3.51) | (690.0) | | | (76.53) |
| Coarse Lt. Wt. | | 1.40 | 0.2 | 278.55 | 26.2% | 38.4% | 30.8925 |
| Sand | | | (7.09) | (619.0) | | | (68.65) |
| 1.905 cm (¾″) | | 0.91 | 0.002 | 1.8 | 0.3% | 0.2% | 0.198 |
| 15 denier PP* | | | (0.07) | (4.0) | | | (0.44) |
| monofilament | | | | | | | |
| Fibers | | | | | | | |
| Foam stabilizer | | 0.06 | 0.351 | 22.32 | 45.8% | 3.1% | 2.475 |
| (from Miracon | | | (12.40) | (49.6) | | | (5.50) |
| Technologies, | | | | | | | |
| Inc.) | | | | | | | |
| Water | 113 L | 1.00 | 0.113 | 111.78 | 14.7% | 15.4% | 12.3975 |
| | (29.8 | | (3.98) | (248.4) | | | (27.55) |
| | Gallons) | | | | | | |

| | Total |
|---|---|
| | Kg/cubic |
| | meters |
| Admixtures | (Oz/cu yd) |
| NC534 (a non chloride | 2.05 (55.2) |
| accelerator admixture) | |
| Delvo ™ (a hydration | 1.02 (27.6) |
| stabilizer admixture | |
| from Masterbuilder) | |
| 200 N (a water reducer, | 0.512 (13.8) |
| low range/retarder) | |
| Glenium ™ 3030 (water | 1.92 (51.75) |
| reducer, high range) | |

Material properties

| | |
|---|---|
| Yield | 0.766 (cubic meters) |
| | (27.05 (cu.ft.)) |
| Specified Unit Weight (kg/cubic | 954 kg/cubic meters |
| meters) (pcf) | (59.56 (pcf)) |
| Water-Cement Ratio | 0.36 (W/C + FA + SF) |
| (W/C + FA + SF) | |

*PP means polypropylene

### Result:

The mix in Table 1 had correct yield but was unstable and started losing volume/air at a rate of 2 to 4 percentage points of volume every 10 minutes.

TABLE 2
Mix Design Using Light Weight Sand

| | | | Absolute | | | | 3 ft³ |
|---|---|---|---|---|---|---|---|
| | | | Volume | Batch | | | Batch |
| | | | (cubic | Weight | Mix % | Mix % | Weight |
| | | Specific | meter) | in kg | by | by | in |
| Materials | | Gravity | (cu.ft.) | (lb.) | Volume | Weight | kg (lb) |
| Cement (Gray- | 7.3 Bags | 3.15 | 0.1 | 310.5 | 13.0% | 43.0% | 34.4925 |
| Type I/II) | (94#) | | (3.51) | (690.0) | | | (76.65) |
| Concrete Sand | | 2.64 | 0.103 | 270 | 13.5% | 37.4% | 29.9925 |
| | | | (3.64) | (600.0) | | | (66.65) |
| 1.905 cm (¾″) | | 0.91 | 0.002 | 1.8 | 0.3% | 0.2% | 0.198 |
| 15 denier PP* | | | (0.07) | (4.0) | | | (0.44) |
| monofilament | | | | | | | |
| Fibers | | | | | | | |
| Foam stabilizer | | 0.06 | 0.447 | 28.44 | 58.5% | 3.9% | 3.159 |
| (from Miracon | | | (15.80) | (63.2) | | | (7.02) |
| Technologies, | | | | | | | |
| Inc.) | | | | | | | |
| Water | 113 L | 1.00 | 0.113 | 111.78 | 14.7% | 15.5% | 12.4155 |
| | (29.8 | | (3.98) | (248.4) | | | (27.59) |
| | Gallons) | | | | | | |

| | Total |
|---|---|
| | Kg/cubic |
| | meters |
| Admixtures | (Oz/cu yd) |
| NC534 (a non chloride | 2.05 (55.2) |
| accelerator admixture) | |
| Delvo ™ (a hydration | 1.02 (27.6) |
| stabilizer admixture | |
| from Masterbuilder) | |
| 200 N (a water reducer, | 0.512 (13.8) |
| low range/retarder) | |
| Glenium ™ 3030 (water | 1.92 (51.75) |
| reducer, high range) | |

Material Properties

| | |
|---|---|
| Yield | 0.765 (cubic meters (27.01 |
| | (cu.ft.)) |
| Specified Unit Weight (kg/cubic | 952 kg/cubic meters (59.46 |
| meters) (pcf) | (pcf)) |
| Water-Cement Ratio | 0.36 (W/C + FA + SF) |
| (W/C + FA + SF) | |

*PP means polypropylene

Results: The mix in Table 2 had correct yield but was unstable and started loosing volume/air at a rate of 2 to 5 percentage points of volume every 10 minutes.

TABLE 3
Mix Design Light Weight - 34,473.8 KPa (5000 psi)

| | | | Absolute | | | | |
|---|---|---|---|---|---|---|---|
| | | | Volume | Batch | | | Cu Ft |
| | | | (cubic | Weight | Mix % | Mix % | Batch |
| | | Specific | meters) | in kg | by | by | Size |
| Materials | | Gravity | (cu.ft.) | (lb.) | Volume | Weight | 1.5 |
| Cement (Gray-Type | 9.8 Bags | 3.15 | 0.084 | 261 | 10.9% | 21.3% | 32.22 |
| I/II) | (94#) | | (2.95) | (580.0) | | | |
| Fly Ash (Class C) | | 2.69 | 0.054 | 144 | 7.0% | 11.8% | 17.78 |
| | | | (1.91) | (320.0) | | | |
| Silica Fume | | 2.20 | 0.005 | 11.25 | 0.7% | 0.9% | 1.39 |
| | | | (0.18) | (25.0) | | | |
| Concrete Sand | | 2.62 | 0.123 | 319.5 | 16.0% | 26.1% | 39.44 |
| | | | (4.34) | (710.0) | | | |
| 1.905 cm (¾″) 15 | | 0.91 | 0.002 | 1.8 | 0.3% | 0.1% | 0.22 |
| denier PP* | | | (0.07) | (4.0) | | | |
| monofilament Fibers | | | | | | | |
| Pea gravel | | 2.62 | 0.130 | 337.5 | 16.9% | 27.6% | 41.67 |
| | | | (4.59) | (750.0) | | | |
| Foam stabilizer (from | | 0.06 | 0.235 | 14.94 | 30.6% | 1.2% | 0.46 |
| Miracon | | | (8.29) | (33.2) | | | |
| Technologies, Inc.) | | | | | | | |
| Water | 134 L | 1.00 | 0.135 | 133.2 | 17.5% | 10.9% | 16.44 |
| | (35.5 | | (4.75) | (296.0) | | | |
| | Gallons) | | | | | | |

| | Total |
|---|---|
| | Kg/cubic |
| | meters |
| Admixtures | (Oz/cu yd) |
| NC534 (a non chloride | 1.721 (46.4) |
| accelerator admixture) | |
| Delvo ™ (a hydration stabilizer | 0.323 (8.7) |
| admixture from Masterbuilder) | |
| | 0 |
| Glenium ™ 3030 (water reducer, | 1.83 (49.3) |
| high range) | |

Material Properties

| | |
|---|---|
| Yield | 0.767 (cubic meters) (27.08 |
| | (cu.ft.)) |
| Specified Unit Weight (kg/cubic | 1608 kg/cubic meters |
| meters (pcf) | (100.39 (pcf)) |
| Water-Cement Ratio | 0.320 (W/C + FA + SF) |
| (W/C + FA + SF) | |

*PP means polypropylene

Test Results: The mix in Table 3 was very unstable with volume/air loss starting in the first five minutes of mixing and lost almost all air volume within 15 minutes.

TABLE 4
Mix Design Light Weight - 34,476.8 KPa (5000 psi)

| | | | Absolute | | | | |
|---|---|---|---|---|---|---|---|
| | | | Volume | Batch | | | Cu Ft |
| | | | (cubic | Weight | Mix % | Mix % | Batch |
| | | Specific | meters) | in kg | by | by | Size |
| Materials | | Gravity | (cu.ft.) | (lb.) | Volume | Weight | 1.5 |
| Cement (Gray-Type | Bags | 3.15 | 0.084 | 261 | 10.9% | 21.3% | 32.22 |
| I/II) | 9.8 (94#) | | (2.95) | (580.0) | | | |
| Fly Ash (Class C) | | 2.69 | 0.054 | 144 | 7.0% | 11.8% | 17.78 |
| | | | (1.91) | (320.0) | | | |
| Silica Fume | | 2.20 | 0.005 | 11.25 | 0.7% | 0.9% | 1.39 |
| | | | (0.18) | (25.0) | | | |
| Concrete Sand | | 2.62 | 0.123 | 319.5 | 16.0% | 26.1% | 39.44 |
| | | | (4.34) | (710.0) | | | |
| PP* 3 denier 1.27 cm | | 0.91 | 0.002 | 1.8 | 0.3% | 0.1% | 0.22 |
| (½″) monofilament | | | (0.07) | (4.0) | | | |
| Fibers | | | | | | | |
| Pea gravel | | 2.62 | 0.130 | 337.5 | 16.9% | 27.6% | 41.67 |
| | | | (4.59) | (750.0) | | | |
| Miracon ® foam | | 0.06 | 0.235 | 14.940 | 30.6% | 1.2% | 0.46 |
| stabilizing surfactant | | | (8.29) | (33.2) | | | |
| (Miracon | | | | | | | |
| Technologies, Inc.) | | | | | | | |
| Water | 134 L | 1.00 | 0.135 | 133.2 | 17.5% | 10.9% | 16.44 |
| | (35.5 | | (4.75) | (296.0) | | | |
| | Gallons) | | | | | | |

| | Total |
|---|---|
| | Kg/cubic |
| | meters |
| | (Oz/cu |
| Admixtures | yd) |
| NC534 (a non chloride accelerator | 1.721 (46.4) |
| admixture) | |
| Delvo ™ (a hydration stabilizer | 0.323 (8.7) |
| admixture from Masterbuilder) | |
| | 0 |
| Glenium ™ 3030 (water reducer, | 1.83 (49.3) |
| high range) | |

Material Properties

| | |
|---|---|
| Yield | 0.767 (cubic meters) (27.08 |
| | (cu.ft.)) |
| Specified Unit Weight (kg/cubic | 1608 kg/cubic meters |
| meters) (pcf) | (100.39 (pcf)) |
| Water-Cement Ratio | 0.320 (W/C + FA + SF) |
| (W/C + FA + SF) | |

*PP means polypropylene

Test Results: The mix in Table 4 yielded 100% and did not change volume with 1 hour of mixing time. These results demonstrate that the 3 denier 1.27 cm (½ inch) fiber performed very well with 100% yield compared to volume design as well as consistent stability through the mixing cycle.

TABLE 5
Mix Design Light Weight - 34,473.8 KPa (5000 psi)

| | | | Absolute | | | | |
|---|---|---|---|---|---|---|---|
| | | | Volume | Batch | | | Cu Ft |
| | | | (cubic | Weight | Mix % | Mix % | Batch |
| | | Specific | meters) | in kg | by | by | Size |
| Materials | | Gravity | (cu.ft.) | (lb.) | Volume | Weight | 1.5 |
| Cement | 9.8 Bags | 3.15 | 0.084 | 261 | 10.9% | 21.4% | 32.22 |
| (Gray-Type I/II) | (94#) | | (2.95) | (580.0) | | | |
| Fly Ash (Class C) | | 2.69 | 0.054 | 144 | 7.1% | 11.8% | 17.78 |
| | | | (1.91) | (320.0) | | | |
| Silica Fume | | 2.20 | 0.005 | 11.25 | 0.7% | 0.9% | 1.39 |
| | | | (0.18) | (25.0) | | | |
| Concrete Sand | | 2.62 | 0.123 | 319.5 | 16.1% | 26.2% | 39.44 |
| | | | (4.34) | (710.0) | | | |
| Pea gravel | | 2.62 | 0.130 | 337.5 | 17.0% | 27.6% | 41.67 |
| | | | (4.59) | (750.0) | | | |
| Miracon ® foam | | 0.06 | 0.235 | 14.940 | 30.7% | 1.2% | 0.46 |
| stabilizing | | | (8.29) | (33.2) | | | |
| surfactant (Miracon | | | | | | | |
| Technologies, Inc.) | | | | | | | |
| Water | 134 L | 1.00 | 0.135 | 133.2 | 17.6% | 10.9% | 16.44 |
| | (35.5 | | (4.75) | (296.0) | | | |
| | Gallons) | | | | | | |

| | Total |
|---|---|
| | Kg/cubic |
| | meters |
| | (Oz/cu |
| Admixtures | yd) |
| NC534 (a non chloride accelerator | 1.721 (46.4) |
| admixture) | |
| Delvo ™ (a hydration stabilizer | 0.323 (8.7) |
| admixture from Masterbuilder) | |
| Viscosity Modifying Agent 362 | 1.721 (46.4) |
| (VMA) | |
| Glenium ™ 3030 (water reducer, | 1.83 (49.3) |
| high range) | |

Material Properties

| | |
|---|---|
| Yield | 0.7646 (cubic meters) (27.00 |
| | (cu.ft.)) |
| Specified Unit Weight (kg/cubic | 1610 kg/cubic meters |
| meters) (pcf) | (100.51 (pcf)) |
| Water-Cement Ratio | 0.320 (W/C + FA + SF) |
| (W/C + FA + SF) | |

*PP means polypropylene

Test Results:

1) The first mix of Table 5 was very unstable losing volume/air at a rapid rate. Most of air volume was lost in 15 to 20 minutes of mixing.

2) A second mix of Table 5 was made increasing the dosage of VMA 362 to 0.473 L per 50.8 kg (16 oz./cwt) of cement and mix was just as unstable as first mix.

3) A third mix of table 5 was made eliminating VMA 362 and using a different VMA—i.e. VMA 450 at a high dosage rate, i.e., 0.207 L per 50.8 kg (7 oz./cwt). The result was the same as the first two mixes.

TABLE 6
Mix Design for 0.765 cubic meter (1 Cu. Yd.) (SSD Basis):

| | | | Volume | | | | | |
|---|---|---|---|---|---|---|---|---|
| | | | In | | | | % | % |
| | | | cubic | Weight | | Mix % | Sand | Cement |
| | | Specific | meters | in kgs | Mix by | By | % P/G | % Fly |
| Materials | | Gravity | (cu ft) | (lbs) | Volume | Weight | % R | Ash |
| Cement Type | 9.5 Sack | 3.15 | 0.129 | 405 | 20.3% | 31.5% | | 100.0% |
| I/II | | | (4.54) | (893.0) | | | | |
| Sand | | 2.65 | 0.147 | 390 | 60.0% | 30.4% | 45.0% | |
| | | | (5.20) | (860.0) | | | | |
| Pea gravel | | 2.70 | 0.025 | 68 | 4.0% | 5.3% | 7.9% | |
| | | | (0.89) | (150.0) | | | | |
| Rock #57 | | 2.84 | 0.144 | 408 | 22.7% | 31.8% | 47.1% | |
| | | | (5.08) | (900.0) | | | | |
| 1.905 (¾″) 15 | | 0.90 | 0.002 | 1.81 | 0.3% | 0.1% | | |
| denier PP* | | | (0.07) | (4.0) | | | | |
| Fibers | | | | | | | | |
| Air Yield | | 0.06 | 0.187 | 12 | 24.4% | 0.9% | | |
| | | | (6.60) | (26.4) | | | | |
| Air Volume | 0.187 cubic | | | | | | | |
| | meters | | | | | | | |
| | (6.6 Cu. Ft.) | | | | | | | |
| Water | 132 L | 1.00 | 0.130 | 132 | 17.2% | 9.3% | | |
| | (34.8 Gallons) | | (4.6) | (290.0) | | | | |

| | Total |
|---|---|
| | kg/cubic |
| | meters |
| | (OZ./Cu. |
| Admixtures | Yd.) |
| Glenium ™ | 2.32 (62.5) |
| 3030 (water | |
| reducer, high | |
| range) | |
| Delvo ™ (a | 0.497 (13.4) |
| hydration | |
| stabilizer | |
| admixture | |
| from | |
| Masterbuilder) | |
| 200N (a water | 0.0 |
| reducer, low | |
| range/retarder) | |

Material Properties

| | |
|---|---|
| Yield | 0.7654 cubic meter (27.03 cu.ft.) |
| Specified Unit Weight kg/cubic meters (pcf) | 1851 kg/cubic meter (115.54 pcf) |
| Water-Cement Ratio (W/C + FA + SF) | 0.32 W/(C + FA + SF) |

Result: 1) The mix of Table 6 was not stable and did not have proper yield. This mix had a fiber dosage rate of 2.37 kg (4 pounds) 1.905 cm (¾″) 15 denier PP fiber per cubic meter (yard). At 5 minutes, the unit weight was 1922 kg/cubic meters (120 pcf) and at 20 minutes the unit weight was 2018 kg/cubic meters (126 pcf). The yield and unit weight were not close to target.

2) A second mix of table 6 was run with the same ingredients and proportions as above except the fiber dosage rate was increased to 2.97 kg (5 pounds) 1.905 cm (¾″) 15 denier PP fiber per cubic meter (yard). The result was no improvement over the mix with unit weight—2034 kg/cubic meters (127 pcf) at 20 minutes and low yield.

TABLE 7
Mix Design for 0.765 cubic meter (1 Cu. Yd.) (SSD Basis):

| | | | Volume | | | | | |
|---|---|---|---|---|---|---|---|---|
| | | | In | | | | % | % |
| | | | cubic | Weight | Mix % | Mix % | Sand | Cement |
| | | Specific | meters | in kgs | by | By | % P/G | % Fly |
| Materials | | Gravity | (cu ft) | (lbs) | Volume | Weight | % R | Ash |
| Cement Type | 9.5 Sack | 3.15 | 0.129 | 405 | 20.3% | 31.5% | | 100.0% |
| I/II | | | (4.54) | (893.0) | | | | |
| Sand | | 2.65 | 0.147 | 390 | 60.0% | 30.4% | 45.0% | |
| | | | (5.20) | (860.0) | | | | |
| Pea gravel | | 2.70 | 0.025 | 68 | 4.0% | 5.3% | 7.9% | |
| | | | (0.89) | (150.0) | | | | |
| Rock #57 | | 2.84 | 0.144 | 408 | 22.7% | 31.8% | 47.1% | |
| | | | (5.08) | (900.0) | | | | |
| PP* 3 denier | | 0.90 | 0.002 | 1.81 | 0.3% | 0.1% | | |
| ½″ | | | (0.07) | (4.0) | | | | |
| monofilament | | | | | | | | |
| Fibers | | | | | | | | |
| Air Yield | | 0.06 | 0.187 | 12 | 24.4% | 0.9% | | |
| | | | (6.60) | (26.4) | | | | |
| Air volume | 0.187 cubic | | | | | | | |
| | meters | | | | | | | |
| | (6.6 Cu.Ft.) | | | | | | | |
| Water | 132 L | 1.00 | 0.130 | 132 | 17.2% | 9.3% | | |
| | (34.8 Gallons) | | (4.6) | (290.0) | | | | |

| | Total |
|---|---|
| | kg/cubic |
| | meters |
| | (OZ./Cu. |
| Admixtures | Yd.) |
| Glenium ™ | 2.32 (62.5) |
| 3030 (water | |
| reducer, high | |
| range) | |
| Delvo ™ (a | 0.497 (13.4) |
| hydration | |
| stabilizer | |
| admixture | |
| from | |
| Masterbuilder) | |
| 200N (a water | 0.0 |
| reducer, low | |
| range/retarder) | |
| | 0 |

Material Properties

| | |
|---|---|
| Yield | 0.7654 cubic meters (27.03 cu.ft.) |
| Specified Unit Weight (kg/cubic meters) (pcf) | 1851 kg/cubic meters (115.54 pcf) |
| Water-Cement Ratio (W/C + FA + SF) | 0.32 W/(C + FA + SF) |

*PP means polypropylene

Result: 1) The mix of Table 7 was stable for 50 minutes and provided 100% yield at targeted unit weight. Like the results in Table 4, these results demonstrate that the 3 denier 1.27 cm (½ inch) fiber performed very well, i.e., stable, predictable and targeted yield and unit weight density.

### EXAMPLE 3

A series of tests were conducted to determine the optimum fiber characteristics. Comparisons were made for fibers of different lengths, deniers and composition. The equipment used in the tests follows:
Standard Laboratory Hobart Mixer
A Fann™ Shearometer
Gram Scale
Pounds Scale

The following compositions were tested:

1.) A first series of tests were done to test the effect of the addition of fibers to the foaming agent itself, without any cementitious materials. One test was done without fibers, as a control, and another with fibers of various types, lengths and deniers. The mix design comprised a Fluorinated Surfactant Foam/Air—Standard, referred to as MF1.
2.) A second series of tests were done to test the foaming agent with cementitious materials. One test was done without fibers, as a control, and another with fibers of various types, lengths, deniers to determine benefit of suspension properties added by various fibers. The mix design comprised a Fluorinated Surfactant Foam/Air in a cementitious batch of 72% air and no aggregates, referred to as MFG1.
3.) A third series of tests were done to test the rate at which the aggregate dropped out of the mix. The mix design comprised a foaming agent with cementitious materials and aggregate having 19% air, referred to as MGL1. These tests determined the suspension capabilities of different denier fibers. Scales were used to measure the incremental drop-out of aggregate.

Shear testing was done for the first and second series of tests using a Fann, Model 240 Shearometer, which is a measuring device used to determine gel strength of a viscous material. The shearometer consists of two 5-gram, 8.9×3.56 cm (3.5×1.4 inch), hollow shear tubes and a sample cup having a graduated scale mounted in the center of the cup base. The graduated scale measures the gel strength in kgs. (pounds) per 9.3 square meters of area (100 square feet of area), a measurement of the thixotropic properties of the fluid.

For each sample, a selected amount of the material to be tested was placed in the sample cup and the 5-gram shear tube was promptly placed over the scale and released to the surface of the material being tested. The distance along the scale over which the shear tube passed as it moved from the surface of the material towards the bottom of the sample cup at one minute and after ten minutes (or until reaching the bottom of the sample cup, whichever occurred first) were observed to determine suspension values.

### Series 1. Foam—Fibers Using Mix Design MF1

### Shear/Suspension Testing

TABLE 8

| | | 10 Minute | |
|---|---|---|---|
| | 1 Minute Result | Result | |
| | kg/9.3 m² | kg/9.3 m² | |
| Product Tested | (lbs/100 ft²) | lbs/100 ft² | Difference |
| Control-Foam | Foam with zero fiber | | |
| without Fibers | content bottomed out | | |
| | in the sample cup after | | |
| | a period of 15 seconds | | |
| 1.) PP* 0.635 cm | bottomed out in the | | |
| (¼″) 7.0 D | sample cup after 20 | | |
| | seconds | | |
| 2.) PP 0.635 cm | Not tested | | |
| (¼″) 15.0 D | | | |
| 3.) PP 1.27 cm | 1.93 (4.25) | 1.54 (3.4) | 0.39 (0.85) |
| (½″) 3.0 D | | | |
| 4.) PP 1.27 cm | 2.49 (5.5) | 1.86 (4.1) | 0.63 (1.4) |
| (½″) 7.0 D | | | |
| 5.) PP 1.27 cm | 3.63 (8) | 1.54 (3.4) | 2.09 (4.6) |
| (½″) 15.0 D | | | |
| 6.) NY 1.27 cm | bottomed out in the | | |
| (½″) 7.0D | sample cup after 22 | | |
| | seconds | | |
| 7.) NY 1.905 cm | 2.04 (4.5) | 1.25 (2.75) | 0.79 (1.75) |
| (¾″) 7.0D | | | |
| 8.) PP 1.905 cm | 2.95 (6.5) | 2.04 (4.5) | 0.91 (2.0) |
| (¾″) 7.0 D | | | |
| 9.) PP 1.905 cm | Not tested | | |
| (¾″) 15.0 D | | | |

Note:
PP means polypropylene.
NY means nylon
D as used in the Tables means denier. Denier is a weight per unit length measure of a linear material, defined as the weight in grams of 9,000 meters of fiber. Lower numbers represent finer sizes.

### Observations:

The Foam control exhibited little value in slowing, or suspending, the drop cylinder during testing.

The 0.635 cm (¼″) fiber added little suspension value.

The 1.27 cm (½″) 3 denier fibers exhibited similar suspension values for both the one and ten minute interval.

The 1.27 (½″) 7 denier fiber exhibited slightly better results after one minute than the 3 denier fiber, but finished similar to the 3 denier fiber after the ten minute interval.

The 1.27 cm (½″) nylon fiber added little benefit. The fiber did not mix well in the foam solution and bottomed out quickly.

The 1.905 cm (¾″) nylon fiber did not mix and distribute well in air/foam only mixture. However, they did suspend as well as the 1.27 cm (½″) 3-7 denier polypropylene fibers when care was taken with mixing and distribution while blending with the air/foam.

### Series 2. Foam/Cementitious Batch—Fibers Using Mix Design MFG1

### Shear/Suspension Testing

TABLE 9

| | | 10 Minute | |
|---|---|---|---|
| | | Result | |
| | 1 Minute Result | Kg/9.3 m² | |
| Product Tested | Kg/9.3 m² (lbs/100 ft²) | (lbs/100 ft²) | Difference |
| Control-Foam | Foam with zero fiber | | |
| without Fibers | content bottomed out in | | |
| | the sample cup after a | | |
| | period of 10 seconds | | |
| 1.) PP 0.635 cm | 2.15 (4.75) | 1.77 (3.9) | 0.38 (0.85) |
| (¼″) 7.0 D | | | |
| 2.) PP 0.635 cm | Not tested | | |
| (¼″) 15.0 D | | | |
| 3.) PP 1.27 cm | 4.99 (11) | 4.54 (10) | 0.45 (1.0) |
| (½″) 3.0 D | | | |
| 4.) PP 1.27 cm | 5.44 (12**) | 2.72 (6**) | 2.72 (6.0**) |
| (½″) 7.0 D | 3.63 (8) | 3.18 (7) | |
| Tested twice | | | 0.45 (1.0) |
| 5.) PP 1.27 cm | 3.67 (8.1) | 3.08 (6.8) | 0.59 (1.3) |
| (½″) 15.0 D | | | |
| 6.) NY 1.27 cm | Not tested | | |
| (½″) 7.0 D | | | |
| 7.) NY 1.905 cm | Clumped in no | | |
| (¾″) 7.0 D | aggregate mix | | |
| 8.) PP 1.905 cm | Clumped twice in | | |
| (¾″) 15.0 D | no aggregate mix | | |
| 9.) PP 1.905 cm | 7.94 (17.5) | 6.58 (14.5) | 1.36 (3.0) |
| (¾″) 15.0 D | | | |

Note:
PP means polypropylene;
NY means nylon;
D means denier.
**It is believed that an error occurred. The test was therefore repeated.

### Observations:

The control—(foam/cementitious) offered no resistance to the drop of the weight and bottomed out quickly at 10 seconds.

The 0.635 (¼″) fibers offered some resistance but did not exhibit the suspension capabilities of longer fibers.

The 1.27 cm (½ ″) polypropylene fibers performed similarly in one minute testing. The 3.0 denier fiber appeared to exhibit slightly better suspension at the 10 minute mark.

The 1.905 cm (¾″) fibers exhibited mixing problems in the no aggregate mixture. Both 7.0 denier samples clumped and balled in the mixture. The 15.0 denier fibers dispersed better in the mixture with care and attention paid to the mixing procedures.

Series Three. Foam—Cementitious/Aggregate Batch Fibers Using Mix Design MFL1

TABLE 10

| | Top 20.3 cm | Bottom | | |
|---|---|---|---|---|
| | (8″) | 20.3 (8″) | | Total 40.6 (16″) |
| | Weight kgs. | Weight kgs. | % of mix | Weight kgs. |
| | (lbs.) | (lbs.) | On bottom | (lbs.) |
| PP - 1.27 cm | 3.88 (8.55) | 4.24 (9.35) | 52.20% | 8.12 (17.9) |
| (½″) 3.0 D | | | | |
| PP - 1.27 cm | 3.72 (8.2) | 4.45 (9.8) | 54.20% | 8.19 (18.05) |
| (½″) 7.0 D | | | | |

### Observations:

There was great distribution of both the 3.0 and 7.0 denier fibers in the batch mix designs.

There was a slight change in the ability to suspend aggregate in the batch mix designs when changing deniers in 1.27 cm (½″) fibers.

The purpose of the series of tests was to compare the suspension capabilities of 3.0 denier 1.27 cm (½″) fibers vs. 7.0 denier 1.27 cm (½″) fibers by weighing the fall out of aggregate particles in the mixture from the top half to the bottom half of the form.

In this test, 40.6 cm (16″) high forms that were split in the middles were used to measure the contents of each half. The identical mix design was used in each batch except that 3.0 denier fibers were added to the first batch and 7.0 denier fibers were added to the second batch.

After the batches were mixed and placed in the forms they were weighed and given 20 minutes to settle. After 20 minutes, each form was separated at mid-point and each bottom half of the cementitious material was weighed and top and bottom half weights were calculated. Both fiber deniers exhibited superior suspension values.

The benefits of adding fibers to foam mixtures is demonstrated by the value noted in short-term and long term suspension abilities. The benefit of the fiber addition appears to have a direct relationship to the size and denier of the fibers and the mix design of materials.

The 0.635 cm (¼″) long fibers offer little benefit at low dosage rates. Although the 0.635 cm (¼″) long fibers may provide better results at higher dosage rates, the increased costs of higher dosage rates would counter the benefit of using the 0.635 cm (¼″) fibers.

The 1.27 cm (½″) fibers exhibited the best distribution properties in no aggregate mixtures and share similar values in short-term and long-term suspension values regardless of rates up to a 15.0 denier.

The 1.27 cm (½″) nylon fibers had poor distribution properties and offered little support to the cylinder weight during the testing process. The backbone of the polypropylene fibers does a better job supporting and suspending the loads placed upon them.

The 1.905 cm (¾″) fibers showed similar suspension abilities as the 1.27 cm (½″) fibers when care was taken to distribute and mix the fibers. Without such care, the 1.905 cm (¾) fibers would clump and ball in the mixture.

### Foam Cementitious Batches and Mix Designs

### Shear Testing

The benefits of adding fibers to foam/cementitious mixtures values are apparent immediately after addition. The values of benefits change with lengths and deniers of fibers. The 0.635 cm (¼″) lengths do not exhibit great suspension values at low dosage rates as would be expected. The 1.27 cm (½″) fibers seem to be the fiber of choice in this mix/batch design because of the ease of introduction and mixing distribution properties. Although both 3.0 and 7.0 denier fibers exhibited good suspension capabilities, the lower denier fiber seem to have somewhat better suspension values and qualities than the mid denier fibers. The 15.0 high denier 1.27 cm (½″) fibers displayed high values in this test.

The 1.905 cm (¾″) fibers reacted as anticipated in the no aggregate mixtures. The nylon and polypropylene low denier fibers balled and clumped in the mixture even when added by hand during the mixing process. The 15.0 denier fiber exhibited high suspension values when separated by hand and introduced into the batch system. Hand separating and adding the longer, coarser fibers to the batching system worked well for testing purposes in a laboratory setting. Because the method for adding fibers to a concrete mix in the field is to add in full batch sizes in a single drop, having to add fibers by hand in a field setting is not practical.

The embodiment of the suspension elements comprised of 1.27 cm (½″) fibers exhibited great mixing and distribution properties with no special attention needed when added.

Foam Cementitious with Aggregate Mix Designs

### Drop Out/Suspension Testing

There is an immediate visual and short-term and long-term placement value exhibited when adding fibers to Foam Cementitious Aggregates batches relating to suspension values. The two fibers that were tested in the foam, cementitious material, and aggregate mixes showed immediate visual suspension properties and long-term placement benefits, as demonstrated by the fall-out results after sitting in the mold for 20 minutes. Normally, aggregate fall out would be evident immediately and noted at very high percentage rates in standard foam cementitious aggregate mixtures without using special aggregates. With the use of fibers the aggregates displayed low percentage rates of settlement during the tests.

The fibers show a definite ability to suspend solids in foam and foam cementitious mixtures using the shear test and drop out test described above in aggregate mixes.

It is believed that longer fibers may be beneficial in large aggregate mixtures that can properly distribute the fibers and make them user friendly in the field. Fiber dosage rates along with length and denier are also very important when the fibers act as a suspension agent.

The light weight, air-entrained fiber suspended concrete mix described herein may be used for any project for which concrete, and particularly light weight concrete, such as foamed concrete, is used. Examples include lightweight flooring, walls, panels, roofing tiles, conduits, architectural and decorative forms, and other well known end products.

An advantage to the fine denier fibers is the support they provide to the mix, including aggregate and air bubbles. Importantly, the addition of fibers also permits modification of the concrete mix design. Without the addition of fine fibers to the mix, sand is necessary for support in the low viscosity system. With fibers in the mix to support the aggregate and the air, less sand is required. When less sand is used, more rock may be used so that the total surface area of particles in the mixture that have to be coated with cement paste is reduced, allowing more cement to be directed to strengthening the concrete. In addition, when fine fibers are added to the mixture, the sieve size of the concrete is maintained. The fibers provide support for suspending the aggregate and the air bubbles in a uniform dispersion throughout the concrete mix, adding stability and strength to the concrete product and allow use of larger aggregate, such as rock and pea gravel, which contributes to increased strength while lowering the total cost. Sand and fine aggregate are not as readily available and thus are often very expensive. Coarse rock is plentiful and therefore less expensive.

It is believed that the method described herein works because there is a strong affinity between the air bubbles and the fine fibers when mixed in a fluid, causing the dispersed fibers to trap the bubbles in a state of dispersion to create a homogenous aerated fibrous suspension. It is believed that the aerated fibrous suspension breaks the velocity of sinking solids, bringing them to a static state. The thixotropic properties of the aerated fibrous suspension are present when the aerated fibrous fluid becomes static. Colloid and polymer thixotrobes require time to gel. The substantially immediate suspension effect of the aerated fibrous suspension fluid prevents the solids from stratifying. The bubbles trapped in the fibrous suspension add buoyancy to the fiber supporting the fibers. This synergistic buoyancy effect between the fiber and bubbles is effective regardless of base slurry viscosity. The fiber matrix cohesively links the suspended solids holding them in a state of dispersion which prevents stratification. The dispersed fiber trapped bubbles act like spacers between the suspended solids, holding them in a state of dispersion and suspension and thereby preventing stratification of the solids. When the matrix becomes static, the suspension solids become continuous and stable, unlike colloid and polymer gels where the velocity of the falling solids is merely slowed down. In sum, the addition of fibers uniformly suspends the aggregate and the air bubbles in the mix, increases the strength of the mix and permits alteration of the mix design without loss of strength or stability, thereby reducing costs.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise indicated, all numbers expressing quantities of ingredients, time, temperatures, and so forth used in the present specification and claims are to be understood as being modified in all instances by the term “about.” Accordingly, unless indicated to the contrary, the numerical parameters set forth in the following specification and claims are approximations that may vary depending upon the desired properties sought to be obtained by the present invention. In this manner, slight variations above and below the stated ranges can be used to achieve substantially the same results as values within the ranges. Also, the disclosure of these ranges is intended as a continuous range including every value between the minimum and maximum values.

Notwithstanding that the numerical ranges and parameters setting forth the broad scope of the invention are approximations, the numerical values set forth in the specific examples are reported as precisely as possible. Any numerical value, however, may inherently contain certain errors necessarily resulting from the standard deviation found in their respective testing measurements. It is to be understood that this invention is not limited to specific compositions, components or process steps disclosed herein, as such may vary.

1. A method for producing a light weight, low to medium density product comprising:
mixing together (i) cementitious components comprising cement and water, and aggregate, (ii) a plurality of suspension elements comprising synthetic fibers, each fiber having a denier of less than 15, a length greater than 0.635 (¼ inch) and less than 1.905 cm (¾ inch) and being made of a material selected from the group consisting of polyolefin, nylon and polyester, and (iii) an agent for lowering the unit weight of the product, to form a concrete mixture;
pouring the concrete mixture into a form; and,
allowing the mixture to harden.

2. The method recited in claim 1 wherein the aggregate comprises at least one of sand, fine aggregate and coarse aggregate.

3. The method recited in claim 1 wherein the synthetic fibers are polypropylene monofilaments having a denier between 2 and 7.

4. The method recited in claim 3 wherein the monofilaments have a denier of between 3 and 7 and a length of about 1.27 cm to 1.905 cm (½ to ¾ inch).

5. The method recited in claim 1 wherein the synthetic fibers are polyolefin monofilaments having a denier between 2 and 7 and a length of about 1.27 cm to 1.905 cm (½ to ¾ inch).

6. The method recited in claim 1 wherein the mixing step comprises:
distributing the suspension elements throughout a slurry of the cementitious components, and adding thereto the unit weight lowering agent.

7. The method recited in claim 1 wherein the mixing step comprises:
adding the suspension elements to the cementitious components, followed by mixing the suspension elements and the cementitious components together;
adding the unit weight lowering agent; and
mixing the unit weight lowering agent with the suspension elements and the cementitious components for a period of time sufficient to disperse the unit weight lowering agent throughout the concrete mixture.

8. The method recited in claim 1 wherein the unit weight lowering agent is selected from air as bubbles, foam and combinations thereof.

9. The method recited in claim 8 wherein the foam comprises from about 1 to 95% by volume of air as bubbles and a foam stabilizing fluorinated surfactant.

10. The method recited in claim 8 further comprising mixing from 0.01 to 20% by weight of a foam stabilizer.

11. The method recited in claim 10 wherein the foam stabilizer is a fluorochemical foam stabilizer.

12. The method recited in claim 10 wherein the foam stabilizer comprises an aqueous solution of fatty alcohols

13. The method recited in claim 1 wherein the cementitious components comprise from 1 to 50% by volume cement, up to 75% by volume sand, up to 60% by volume coarse aggregate, from 4-50% by volume water and from 1 to 90% by volume of air as bubbles.

14. The method recited in claim 1 wherein the mixing step further comprises adding at least one admixture selected from the group consisting of water reducers, retarders, accelerators, hydration stabilizers, and combinations thereof.

15. The method recited in claim 1 wherein 2.37 to 2.97 kg (four to five pounds) of suspension elements per cubic meter (cubic yard) of concrete are added.

16. The method recited in claim 1 further comprising mixing up to 50% by volume of at least one of cementitious and pozzolanic materials.

17. The method recited in claim 16 further comprising mixing up to 0.6 kg (20 oz) of a water reducer per 45 kg (100 pounds) of cementitious and pollazolanic material.

18. The method recited in claim 16 further comprising mixing up to 0.6 kg (20 oz) of an accelerator per 45 kg (100 pounds) of cementitious and pollazolanic material.

19. A cementitious product comprised of air-entrained concrete having a plurality of suspension elements dispersed throughout for suspending air and aggregate within the concrete, said suspension elements comprising synthetic fibers having a denier of less than 15, a length of about 0.635 to 1.905 cm (¼ to ¼ inch) and being made of a material selected from the group consisting of polyolefin, nylon and polyester.

20. The cementitious product recited in claim 19 further comprising from 1 to 50% by volume cement, up to 75% by volume sand, up to 60% by volume coarse aggregate, and from 1 to 90% by volume of air as bubbles.

21. The cementitious product recited in claim 19 further comprising up to 50% by volume of a member selected from the group consisting of cementitious and pozzolanic materials.

22. The cementitious product recited in claim 19 wherein the synthetic fibers are polyolefin monofilaments having a denier between 2 and 7 and a length of about 1.27 to 1.905 cm (½ to ¾ inch).

23. Suspension elements for suspending air bubbles and aggregate in gasified or aerated liquids and gels comprising:
a plurality of synthetic fibers, each having a denier of less than 15, a length of about 1.27 to 1.905 cm (½ to ¾ inch) and being made of a material selected from the group consisting of polyolefin, nylon and polyester.

24. The suspension elements recited in claim 23 wherein the synthetic fibers are polyolefin monofilaments having a denier between 2 and 7.

25. The suspension elements recited in claim 23 wherein the aerated liquid or gel is concrete.
